(19) United States
(12) Patent Application Publication
(10) Pub. No.: US 2014/0035410 A1
(43) Pub. Date: Feb. 6, 2014

(54) ROTATING DEVICE

(71) Applicant: Samsung Electro-Mechanics Japan Advanced Technology Co., Ltd., Shizuoka (JP)

(72) Inventors: Mitsuo KODAMA, Shizuoka (JP); Ryusuke SUGIKI, Shizuoka (JP); Kazuhiro MATSUO, Shizuoka (JP)

(21) Appl. No.: 13/917,393

(22) Filed: Jun. 13, 2013

(30) Foreign Application Priority Data
Aug. 1, 2012 (JP) 2012-170837

(51) Int. Cl. H02K 7/08

(52) U.S. Cl. CPC H02K 7/086
USPC 310/90

(57) ABSTRACT

A rotating device is a device in which a sleeve of a rotor surrounds a shaft of a fixed body, a lubricant intervening between the shaft and the sleeve. A gap between the shaft and the sleeve includes two dynamic pressure generation portions spaced apart from each other in an axial direction. The rotor and the fixed body are arranged such that a center of gravity of the rotor having a plurality of magnetic recording disks mounted thereon is positioned between the two dynamic pressure generation portions.

The present application claims the benefit of Japanese Patent Application No. 2012-170837 filed Aug. 1, 2012. The disclosure of this application is hereby incorporated in its entirety by reference as if fully set forth herein.

### BACKGROUND OF THE INVENTION

1. Field of the Invention

The present invention relates to a rotating device of fixed-shaft type.

2. Description of the Related Art

Disk drive devices, such as hard disk drives, have become miniaturized. The capacity of a disk drive device has also been increased. Such disk drive devices have been installed in various types of electronic devices. In particular, such disk drive devices have been installed in portable electronic devices such as laptop computers or portable music players. With regard to disk drive devices that are installed in portable electronic devices, their impact resistance and/or vibration resistance have been required to be improved so that the disk drive devices can withstand impacts, such as those due to dropping, compared with the case of stationary electronic devices such as personal computers.

For example, in Japanese Patent Application Publication No. 2009-162246 or Japanese Patent Application Publication No. 2010-127448, a motor in which a shaft is fixed to a baseplate and a fluid dynamic bearing is adopted as a bearing is proposed.

### SUMMARY OF THE INVENTION

In order to increase the capacity of the hard disk drive, it is one option to mount more magnetic recording disks on the drive. However, in general, the greater the number of magnetic recording disks is, the further from the base the position of the center of gravity of the rotor is, accordingly. It becomes more likely for the rotating rotor to lose balance when the center of gravity of the rotor becomes further from the base. Unbalance of the rotor may increase read/write errors of data.

In order to maintain the balance during rotation, it is one option to increase stiffness of the bearing by increasing the dynamic pressure generated by the fluid dynamic bearing. However, increase of the dynamic pressure may facilitate movement of a lubricant during rotation. As a result, it maybe possible to have an excess amount of lubricant at certain position and/or to have an insufficient amount of lubricant at another position. It is not preferred to have the excess amount of lubricant at an gas-liquid interface of the lubricant because it becomes more likely for the lubricant to scatter out of the gas-liquid interface. Therefore, it is not so simple to increase the number of magnetic recording disks to be mounted.

The present invention addresses these disadvantages, and a general purpose of one embodiment of the present invention is to provide a rotating device that can incorporate more recording disks while keeping a rotating rotor well-balanced.

An embodiment of the present invention relates to a rotating device. The rotating device is a device in which a sleeve of a rotor surrounds a shaft of a fixed body, a lubricant intervening between the shaft and the sleeve, and in which a gap between the shaft and the sleeve includes two dynamic pressure generation portions spaced apart from each other in an extension direction in which the shaft extends. The rotor and the fixed body are arranged such that a center of gravity of the rotor having a plurality of recording disks mounted thereon is positioned between the two dynamic pressure generation portions.

Optional combinations of the aforementioned constituting elements and implementations of the invention in the form of methods, apparatuses, or systems may also be practiced as additional modes of the present invention.

### BRIEF DESCRIPTION OF THE DRAWINGS

Embodiments will now be described, by way of example only, with reference to the accompanying drawings, which are meant to be exemplary, not limiting, and wherein like elements are numbered alike in several figures, in which:

FIG. 1A, FIG. 1B and FIG. 1C are views of a rotating device according to an embodiment;

FIG. 2 is a section view sectioned along line A-A in FIG. 1C.

### DETAILED DESCRIPTION OF THE INVENTION

The invention will now be described by reference to the preferred embodiments. This does not intend to limit the scope of the present invention but to exemplify the invention. The size of the component in each figure may be changed in order to aid understanding. Some of the components in each figure may be omitted if they are not important for explanation.

A rotating device according to an embodiment of the present invention is preferably used as a disk drive device such as a hard disk drive having and rotating a magnetic recording disk. In particular, the rotating device according to the embodiment is preferably used as a disk drive device of fixed-shaft type in which a shaft is fixed to a base and a hub rotates with respect to the shaft. In particular, the rotating device according to the embodiment is preferably used as a hard disk drive of high capacity installed in a server.

The rotating device according to the embodiment is fixed-shaft type; that is, the sleeve of the rotor surrounds the shaft of the fixed body, a lubricant intervening between the shaft and the sleeve. An extension direction in which the shaft extends is substantially parallel to the rotational axis of the rotor or an axial direction. The rotating device adopts the fluid dynamic bearing. In particular, a gap between the shaft and the sleeve includes two radial dynamic pressure generation portions spaced apart from each other in the axial direction. The rotor and the fixed body are arranged such that a center of gravity of the rotor having a plurality of magnetic recording disks mounted thereon is positioned between the two radial dynamic pressure generation portions. By doing so, the rotating rotor becomes well-balanced and read/write errors decrease. Alternatively/additionally, vibration resistance or impact resistance of the rotating device may be improved.

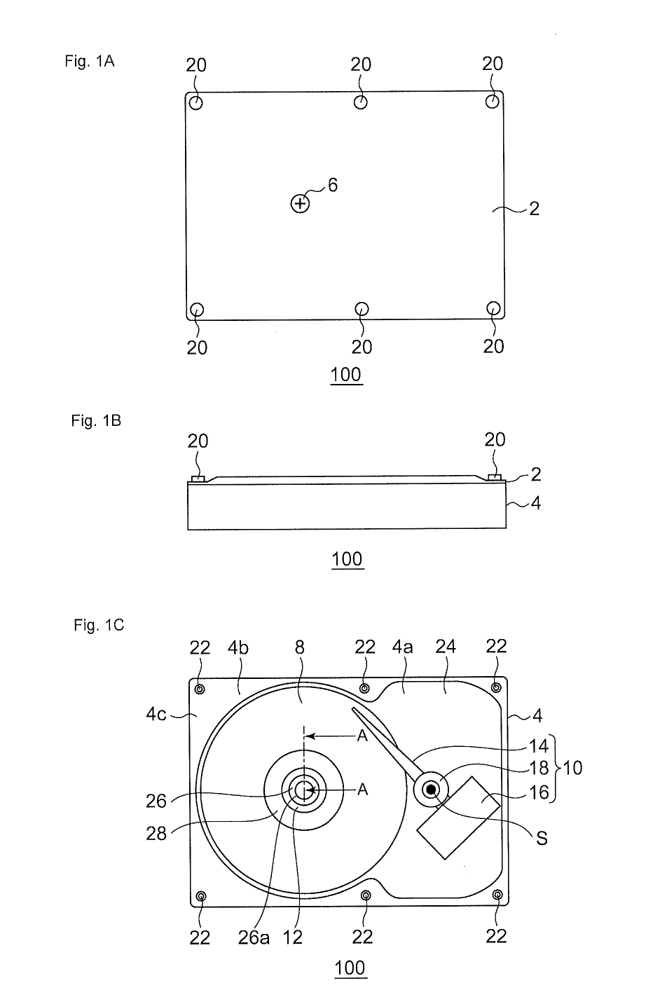

FIG. 1A FIG. 1B and FIG. 1C are views of the rotating device 100 according to the embodiment. FIG. 1A is a top view of the rotating device 100. FIG. 1B is a side view of the rotating device 100. FIG. 1C is a top view of the rotating device 100 when the top cover 2 is removed. The rotating device 100 comprises: a fixed body; a rotor which rotates with respect to the fixed body; magnetic recording disks 8 mounted to the rotor; and a data read/write unit 10. The fixed body includes a base 4, a shaft 26 fixed to the base 4, a top cover 2, six screws 20 and a screw 6 for affixing the shaft. The rotor includes a hub 28 and a cap 12. Hereinafter, it is assumed that the side of the base 4 on which the hub 28 is installed is the “upper” side.

The magnetic recording disks 8 are 3.5-inch type glass magnetic recording disks, the diameter of which being 95 mm. The diameter of the central hole of the magnetic recording disk 8 is about 25 mm and the thickness of the disk 8 is about 1.27 mm. Five magnetic recording disks 8 are mounted on the hub 28. The base 4 is produced by die-casting an alloy of aluminum. The base 4 includes: a bottom plate 4a forming the bottom portion of the rotating device 100; and an outer circumference wall 4b formed along the outer circumference of the bottom plate 4a so that the outer circumference wall 4b surrounds an installation region of the magnetic recording disks 8. Six screw holes 22 are formed on the upper surface 4c of the outer circumference wall 4b.

The data read/write unit 10 includes: a read/write head (not shown); a swing arm 14; a voice coil motor 16; and a pivot assembly 18. The read/write head is attached to the tip of the swing arm 14. The read/write head records data onto and reads out data from the magnetic recording disk 8. The pivot assembly 18 swingably supports the swing arm 14 with respect to the base 4 around the head rotation axis S. The voice coil motor 16 swings the swing arm 14 around the head rotation axis S and moves the read/write head to the desired position on the upper surface of the magnetic recording disk 8. The voice coil motor 16 and the pivot assembly 18 are constructed using a known technique for controlling the position of the head.

The top cover 2 is fixed onto the upper surface 4c of the outer circumference wall 4b of the base 4 using six screws 20. The six screws 20 correspond to the six screw holes 22, respectively. In particular, the top cover 2 and the upper surface 4c of the outer circumference wall 4b are fixed together so that the joint portion between both does not create a leak into the inside of the rotating device 100. The inside of the rotating device 100, for example, is a clean space 24 surrounded by the bottom plate 4a of the base 4 and the outer circumference wall 4b of the base 4 and the top cover 2. This clean space 24 is designed so that the clean space 24 is sealed, in other words, there is neither leakage from the outside or to the outside. The clean space 24 is filled with clean gas, with particles removed. As a result, it is less likely for extraneous material such as particles to adhere to the magnetic recording disks 8; thereby the reliability of the rotating device 100 is improved.

A screw hole 26a for affixing the shaft is provided on an upper end surface of the shaft 26. The lower end of the shaft 26 is fixed to the base 4 in a manner as described below. The screw 6 for affixing the shaft penetrates the top cover 2 and is screwed in the screw hole 26a for affixing the shaft. This causes the upper end of the shaft 26 to be fixed to both the top cover 2 and the base 4.

Among others, the above-described type of the rotating device in which both ends of the shaft 26 are fixed to the chassis (for example, the base 4 and/or the top cover 2) can improve the impact resistance and/or the vibration resistance of the rotating device. In this type of the rotating device, if the fluid dynamic bearing is adopted, there in general exist two gas-liquid interfaces of the lubricant.

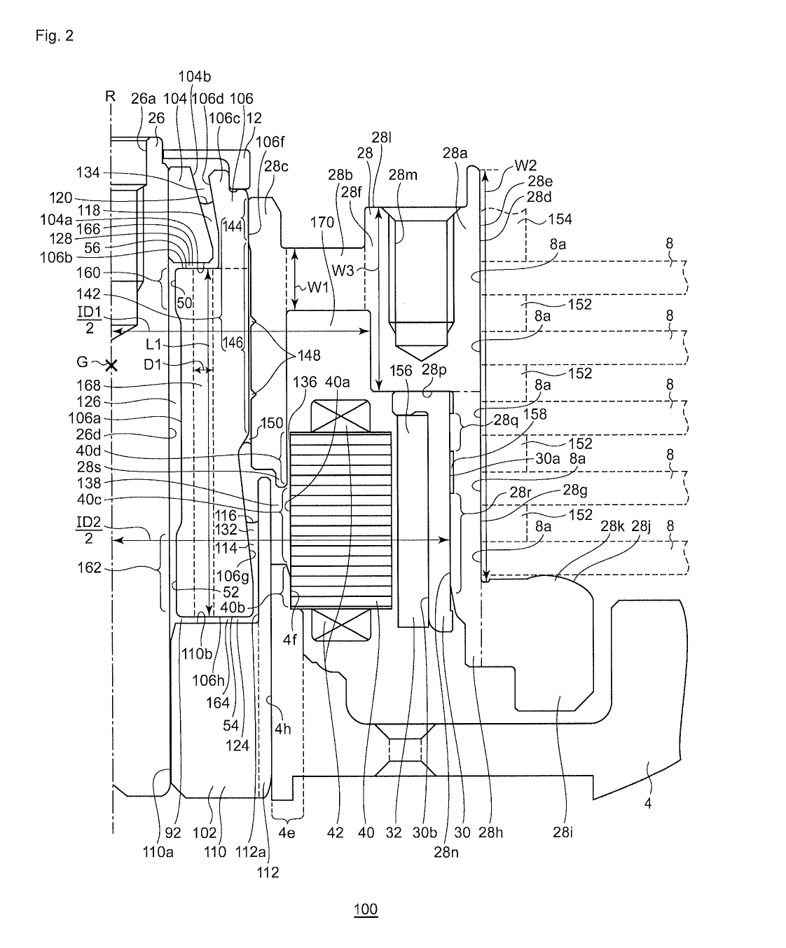

FIG. 2 is a view that is sectioned along the line A-A, as illustrated in FIG. 10. The rotor includes the hub 28, a yoke 30, a cylindrical magnet 32, a sleeve 106 and the cap 12. The fixed body includes the base 4, a laminated core 40, coils 42, a housing 102, the shaft 26 and a jetty surrounding portion 104. Lubricant 92 continuously exists in a part of a gap between the rotor and the fixed body.

In a process of manufacturing the rotating device 100, a fluid dynamic bearing unit which includes the housing 102, the sleeve 106, the jetty surrounding portion 104, the lubricant 92 and the shaft 26 is manufactured. Then, the hub 28 and the base 4 are mounted on the fluid dynamic bearing unit to form the rotating device 100. The base 4 rotatably supports the hub 28 through the fluid dynamic bearing unit.

The hub 28 is fixed on the outer side of the sleeve 106. The hub 28 is made of soft-magnetic steel such as SUS430F or aluminum. The hub 28 is formed to be predetermined cup-like shape by, for example, the press working or cutting of a steel plate. The hub 28 has a central hole along the rotational axis R. For example, the hub 28 may preferably be made of the stainless steel (DHS1) provided by Daido Steel Co., Ltd. since the stainless steel has lower outgas and is easily-worked. The hub 28 may more preferably be made of the stainless steel (DHS2) provided by Daido Steel Co., Ltd. since the stainless steel has high corrosion resistance.

The hub 28 includes an outer frame portion 28a; an intermediate portion 28b; and an inner frame portion 28c, those three portions being arranged in order from outside in a radial direction (i.e. in a direction perpendicular to the rotational axis R). The intermediate portion 28b is positioned in between the outer frame portion 28a and the inner frame portion 28c. The intermediate portion 28b mechanically couples the outer frame portion 28a and the inner frame portion 28c together.

The inner frame portion 28c is attached to an outer surface 106f of an upper part of the sleeve 106. The attachment portion 142 between the inner frame portion 28c and the sleeve 106 includes a shrink-fit portion 144 and a clearance-glue-fit portion 146. The clearance-glue-fit portion 146 has two glue holding portions 148. Glue 150 exists in the two glue holding portions 148 and the clearance-glue-fit portion 146.

When attaching the hub 28 to the sleeve 106, the hub 28 is temporarily fixed to the sleeve 106 due to the shrink-fit portion 144 until the glue 150 held in the two glue holding portions 148 and the clearance-glue-fit portion 146 is cured. The process of curing the glue 150 held in the two glue holding portions 148 and the clearance-glue-fit portion 146 is completed while the temporary fixing is in effect; thereby a required fixing strength is obtained. This may improve perpendicularity of the hub 28, compared with, for example, the case where the required fixing strength is obtained by all press fit joint.

The outer frame portion 28a has an outer surface or an outer cylindrical surface 28d on which central holes 8a of the five magnetic recording disks 8 are fit. The outer frame portion 28a includes: a first ring portion 28f the outer surface of which is an upper part 28e of the outer cylindrical surface 28d, the first ring portion 28f having a first inner diameter ID1; a second ring portion 28h the outer surface of which is a lower part 28g of the outer cylindrical surface 28d, the second ring portion 28h having a second inner diameter ID2 which is greater than the first inner diameter ID1; and a seating portion 28i provided radially outside of the second ring portion 28h.

The magnetic recording disk 8 is seated on a disk-mount surface 28j which is an upper surface of the seating portion 28i. A protruding portion 28k which protrudes upward for seating the magnetic recording disk 8 is formed on the disk-mount surface 28j. The protruding portion 28k is formed in a ring shape the center of which is along the rotational axis R. A surface of the protruding portion 28k on which the magnetic recording disk 8 is seated is a smoothly curved surface. The cross section of the curved surface is in a shape of an arc.

A ring-shaped spacer 152 is inserted in between two magnetic recording disks 8 which are adjacent to each other in the axial direction. The clamper 154 presses the five magnetic recording disks 8 and the four spacers 152 against the protruding portion 28k of the disk-mount surface 28j. The clamper 154 is fixed on an upper surface 28l of the hub 28 by a plurality of clamp screws (not shown). In particular, the clamp screw is screwed in a clamp screw hole 28m provided in the first ring portion 28f.

The second ring portion 28h is in between the magnetic recording disks 8 and the yoke 30 in the radial direction. An inner surface 28n of the second ring portion 28h and a lower surface 28p of the first ring portion 28f define a ring-shaped magnet accommodation region 156. The yoke 30 and the cylindrical magnet 32 are accommodated in the magnet accommodation region 156.

The cross section of the yoke 30 is in a reverse-“L” shape. The yoke is made of magnetic material such as steel. The yoke 30 is fixed to the inner surface 28n of the second ring portion 28h with combination of glue and press-fit. A first projecting portion 28q and a second projecting portion 28r are formed on the inner surface 28n of the second ring portion 28h. In a process of press-fitting the yoke 30, the yoke 30 is pressed against those two portions 28q, 28r. Both the first projecting portion 28q and the second projecting portion 28r are ring-shaped portions formed around the rotational axis R. Those two portions 28q, 28r are spaced apart from each other in the axial direction with the first projecting portion 28q being on the upper side of the second projecting portion 28r. A glue 158 is filled in a region between the inner surface 28n of the second ring portion 28h and an outer surface 30a of the yoke 30. This is realized by applying a suitable amount of the glue 158 on the inner surface 28n of the second ring portion 28h in a process of press-fitting the yoke 30 against the hub 28.

The cylindrical magnet 32 is glued on an inner surface 30b of the yoke 30. The cylindrical magnet 32 is made of a rare-earth material such as Neodymium, Iron, or Boron. The cylindrical magnet 32 faces radially towards twelve teeth of the laminated core 40. The cylindrical magnet 32 is magnetized for driving, with sixteen poles along the circumferential direction (i.e. in a tangential direction of a circle the center of which is in the rotational axis R, the circle being perpendicular to the rotational axis R). The surface of the cylindrical magnet 32 is treated with electrodeposition coating or spray coating to prevent rusting. It can be said that the cylindrical magnet 32 is fixed with respect to the hub 28 through the yoke 30.

The laminated core 40 has a ring portion and twelve teeth, which extend radially outwardly from the ring portion, and is fixed on the upper surface side of the base 4. The laminated core 40 is formed by laminating seventeen thin magnetic steel sheets and mechanically integrating them. An insulation coating is applied onto the surface of the laminated core 40 by electrodeposition coating or powder coating. Each of the coils 42 is wound around one of the teeth of the laminated core 40, respectively. A driving flux is generated along the teeth by applying a three-phase sinusoidal driving current through the coils 42.

The base 4 includes a cylindrical protruding portion 4e the center of which is along the rotational axis R. The protruding portion 4e protrudes upward from the upper surface of the base 4 such that the protruding portion 4e surrounds the housing 102. The laminated core 40 is fixed to the base 4 by fitting a lower part 40b of a central hole 40a of the ring portion of the laminated core 40 into an outer surface 4f of the protruding portion 4e. In particular, the ring portion of the laminated core 40 is fitted to the protruding portion 4e with a press-fit or clearance fit and glued thereon. The upper part 40d of the central hole 40a faces the inner frame portion 28c, a seventh gap 136 being interposed between the upper part 40d and the inner frame portion 28c. An intermediate part 40c of the central hole 40a between the lower part 40b and the upper part 40d faces the housing 102, a eighth gap 138 being interposed between the intermediate part 40c and the housing 102. The eighth gap 138 is wider than the seventh gap 136.

The housing 102 is made of ferrous material such as SUS. The housing 102 includes a flat and ring-shaped shaft holding portion 110 and a cylindrical sleeve surrounding portion 112 fixed on the outer side of the shaft holding portion 110. The shaft holding portion 110 and the sleeve surrounding portion 112 are coupled together so that the whole outer surface of the shaft holding portion 110 touches a lower part of the inner surface 112a of the sleeve surrounding portion 112. In particular, the shaft holding portion 110 and the sleeve surrounding portion 112 are integrated as a single unit. In this case, a manufacturing error of the housing 102 may be reduced and a step of coupling to form the housing 102 may become unnecessary. The sleeve surrounding portion 112 is surrounded by the protruding portion 4e. In particular, the sleeve surrounding portion 112 is fixed with glue in a bearing hole 4h the center of which is along the rotational axis R. The bearing hole 4h formed in the base 4 is an inner surface of the protruding portion 4e.

The inner frame portion 28c has a hub entering portion 28s which at least partly enters in the eighth gap 138 between the sleeve surrounding portion 112 and the ring portion of the laminated core 40. A gap between the hub entering portion 28s and the sleeve surrounding portion 112 and a gap between the hub entering portion 28s and the central hole 40a of the ring portion of the laminated core 40, together with the seventh gap 136, function as a labyrinth with respect to gas of the lubricant 92 evaporated from a first gas-liquid interface 116. The labyrinth can prevent gas of the lubricant 92 from reaching the magnetic recording disks 8.

The lower end of the shaft 26 is inserted into a shaft hole 110a the center of which is along the rotational axis R and is fixed with glue or press-fit therein. The shaft hole 110a is provided in the shaft holding portion 110. The shaft hole 110a may be an inner surface of the shaft holding portion 110. The jetty surrounding portion 104 surrounds an upper end of the shaft 26 and is fixed to the shaft 26.

The sleeve 106 is formed by the steps of: (i) cutting base material (such as brass, aluminum or DHS1) to form a desired shape; and (ii) nickel plating the resultant of the cutting work. The sleeve 106 surrounds an intermediate portion of the shaft 26 which is in between a portion fit in the shaft hole 110a and a portion surrounded by the jetty surrounding portion 104. The lubricant 92 intervenes between the sleeve 106 and the intermediate portion of the shaft 26. In other words, an inner surface 106a of the sleeve 106 faces an outer surface 26d of the intermediate portion of the shaft 26. A first gap 126 is interposed between the inner surface 106a and the outer surface 26d and is filled with the lubricant 92.

The first gap 126 includes two radial dynamic pressure generation portions 160, 162. Dynamic pressure in the radial direction is generated in the lubricant 92 existing in each of the two radial dynamic pressure generation portions 160, 162 when the rotor rotates. The two radial dynamic pressure generation portions 160, 162 are spaced apart from each other in the axial direction. The first radial dynamic pressure generation portion 160 is positioned above the second radial dynamic pressure generation portion 162. A first herringbone-shaped or spiral-shaped radial dynamic pressure generation grooves 50 are formed on a part of the inner surface 106a of the sleeve 106 corresponding to the first radial dynamic pressure generation portion 160. A second herringbone-shaped or spiral-shaped radial dynamic pressure generation grooves 52 are formed on a part of the inner surface 106a of the sleeve 106 corresponding to the second radial dynamic pressure generation portion 162. In other embodiments, at least one of the first radial dynamic pressure generation grooves 50 and the second radial dynamic pressure generation grooves 52 may be formed on the outer surface 26d of the intermediate portion of the shaft 26 instead of the inner surface 106a of the sleeve 106.

The sleeve 106 is in between the jetty surrounding portion 104 and the shaft holding portion 110 in the axial direction. The lubricant 92 intervenes between the sleeve 106 and the jetty surrounding portion 104. The lubricant 92 intervenes between the sleeve 106 and the shaft holding portion 110. In other words, an upper surface 106b of the sleeve 106 faces a lower surface 104a of the jetty surrounding portion 104. A second gap 128 is interposed between the upper surface 106b and the lower surface 104a and is filled with the lubricant 92. A lower surface 106h of the sleeve 106 faces an upper surface 110b of the shaft holding portion 110. A third gap 124 is interposed between the lower surface 106h and the upper surface 110b and is filled with the lubricant 92.

The third gap 124 includes a first thrust dynamic pressure generation portion 164. Dynamic pressure in the axial direction is generated in the lubricant 92 existing in the first thrust dynamic pressure generation portion 164 when the rotor rotates. A first herringbone-shaped or spiral-shaped thrust dynamic pressure generation grooves 54 are formed on a part of the lower surface 106h of the sleeve 106 corresponding to the first thrust dynamic pressure generation portion 164. In other embodiments, the first thrust dynamic pressure generation grooves 54 may be formed on the upper surface 110b of the shaft holding portion 110 instead of the lower surface 106h of the sleeve 106.

The second gap 128 includes a second thrust dynamic pressure generation portion 166. Dynamic pressure in the axial direction is generated in the lubricant 92 existing in the second thrust dynamic pressure generation portion 166 when the rotor rotates. A second herringbone-shaped or spiral-shaped thrust dynamic pressure generation grooves 56 are formed on a part of the upper surface 106b of the sleeve 106 corresponding to the second thrust dynamic pressure generation portion 166. In other embodiments, the second thrust dynamic pressure generation grooves 56 maybe formed on the lower surface 104a of the jetty surrounding portion 104 instead of the upper surface 106b of the sleeve 106.

When the rotor rotates with respect to the fixed body, the first radial dynamic pressure generation grooves 50, the second radial dynamic pressure generation grooves 52, the first thrust dynamic pressure generation grooves 54 and the second thrust dynamic pressure generation grooves 56 cause dynamic pressure to be generated in the lubricant 92. This dynamic pressure supports the rotor in both the radial direction and the axial direction while preventing the rotor from touching the fixed body.

With regard to the positional relationship between the sleeve surrounding portion 112 and the sleeve 106, the sleeve surrounding portion 112 surrounds a lower part of the sleeve 106. A first taper seal (or capillary seal) 114, where a fourth gap 132 between an inner surface 112a of the sleeve surrounding portion 112 and an outer surface 106g of the lower part of the sleeve 106 gradually increases upward, is formed between the sleeve surrounding portion 112 and the sleeve 106. In particular, (i) the inner surface 112a of the sleeve surrounding portion 112 is formed substantially parallel to the rotational axis R and (ii) the outer surface 106g of the lower part of the sleeve 106 is formed such that the upper a position in the outer surface 106g is, the less the diameter of the outer surface 106g at the position is. The facts (i) and (ii) realize the tapered shape of the first taper seal 114. The first taper seal 114 has the first gas-liquid interface 116 of the lubricant 92 and suppresses the leakage of the lubricant 92 by way of the capillary effect. In that, the lubricant 92 at least partly intervenes between the sleeve 106 and the sleeve surrounding portion 112. The first gas-liquid interface 116 of the lubricant 92 touches both the inner surface 112a of the sleeve surrounding portion 112 and the outer surface 106g of the lower part of the sleeve 106.

The sleeve 106 has an upper taper forming portion 106c which faces the jetty surrounding portion 104 in the radial direction. The upper taper forming portion 106c surrounds the jetty surrounding portion 104. A second taper seal (or capillary seal) 118, where a fifth gap 134 between an inner surface 106d of the upper taper forming portion 106c and an outer surface 104b of the jetty surrounding portion 104 gradually increases upward, is formed between the upper taper forming portion 106c and the jetty surrounding portion 104. In particular, the inner surface 106d of the upper taper forming portion 106c is formed such that the upper a position in the inner surface 106d is, the less the diameter of the inner surface 106d at the position is. The outer surface 104b of the jetty surrounding portion 104 is formed such that the upper a position in the outer surface 104b is, the less the diameter of the outer surface 104b at the position is. The rate of decrease of the diameter of the inner surface 106d of the upper taper forming portion 106c is less than the rate of the decrease of the diameter of the outer surface 104b of the jetty surrounding portion 104. According to these, the taper shape of the second taper seal 118 is realized. When the rotor rotates, a force directed radially outward due to a centrifugal force is applied to the lubricant 92 in the second taper seal 118. Since the inner surface 106d of the upper taper forming portion 106c is formed such that the upper a position in the inner surface 106d is, the less the diameter of the inner surface 106d at the position is, the force acts to such in the lubricant 92.

The second taper seal 118 has the second gas-liquid interface 120 of the lubricant 92 and suppresses the leakage of the lubricant 92 by way of the capillary effect. In that, the lubricant 92 at least partly intervenes between the upper taper forming portion 106c and the jetty surrounding portion 104. The second gas-liquid interface 120 of the lubricant 92 touches both the inner surface 106d of the upper taper forming portion 106c and the outer surface 104b of the jetty surrounding portion 104.

A bypass communication hole 168 is provided in the sleeve 106, which bypasses the first radial dynamic pressure generation portion 160 and the second radial dynamic pressure generation portion 162. In particular, the upper side of the first radial dynamic pressure generation portion 160 communicates with the lower side of the second radial dynamic pressure generation portion 162 through the bypass communication hole 168. The upper end of the bypass communication hole 168 exists in the second gap 128 and the lower end of the bypass communication hole 168 exists in the third gap 124. The bypass communication hole 168 is a hole which penetrates the sleeve 106 in the axial direction. The bypass communication hole 168 is formed such that the length L1 of the bypass communication hole 168 ranges from twenty times to sixty times the diameter D1 of the bypass communication hole 168. For example, the diameter D1 of the bypass communication hole 168 ranges from 0.25 mm to 0.50 mm and the length L1 of the bypass communication hole 168 is about 12.89 mm.

Since the rotating device 100 is arranged to hold many magnetic recording disks 8, the rotating device 100 tends to be longer in the axial direction. In addition, the rotating device 100 can be designed so that the bearing span or the separation, in the axial direction, between the first radial dynamic pressure generation portion 160 and the second radial dynamic pressure generation portion 162 is as long as possible, in order to ensure high stiffness of the radial bearing. Therefore, the bypass communication hole 168 tends to be long. In general, it is technically difficult or time-consuming to form a long and fine hole by drilling. To cope with this, in the present embodiment, the diameter D1 of the bypass communication hole 168 is made larger in response to the length L1 of the bypass communication hole 168. Therefore, the workability of the bypass communication hole 168 increases.

The ring-shaped cap 12 is fixed on the upper surface of the upper taper forming portion 106c so that the cap 12 covers the second gas-liquid interface 120 and the jetty surrounding portion 104. The cross section of the cap 12 is in a reverse-“L” shape.

The center of gravity G of the rotor having five magnetic recording disks 8 mounted on the hub 28 is positioned between the two radial dynamic pressure generation portions 160, 162 in the axial direction or in the bearing span. In general, the greater the number of magnetic recording disks 8 which are mounted on the hub 28 is, the higher a position of the center of gravity of the rotor having these magnetic recording disks 8 becomes (i.e. the center of gravity tends to move upward). In this embodiment, it is realized to lower the center of gravity of the rotor while mounting more than four magnetic recording disks 8 due mainly to the following three structures:

Structure 1: the width W1, in the axial direction, of the intermediate portion 28b ranges from one-tenth to one-fifth of a width W2, in the axial direction, of the outer cylindrical surface 28d. In an example, the width W1 is about 2.15 mm and the width W2 is about 14.12 mm.

Structure 2: the width W3, in the axial direction, of the first ring portion 28f ranges from twice to quadruple of the width W1, in the axial direction, of the intermediate portion 28b. In an example, the width W3 is about 6.37 mm.

According to the structure 1 and/or the structure 2, the intermediate portion 28b becomes relatively thin and weight saving of the upper part of the hub 28 can be realized. This may contribute to lowering the center G of gravity of the rotor.

A chuck area 170 surrounded by the first ring portion 28f, the intermediate portion 28b and the inner frame portion 28c is used as a chuck when cutting the hub 28.

Structure 3: the inner frame portion 28c at least partly enters in a region between the ring portion of the laminated core 40 and the sleeve 106. By forming the inner frame portion 28c relatively downwardly long, it is possible to lower the center G of gravity of the rotor.

The operation of the rotating device 100 as described above shall be described below. The three-phase driving current is supplied to the coils 42 to rotate the magnetic recording disk 8. Fluxes are generated along the twelve teeth by making the driving current flow through the coils 42. These fluxes give torque to the cylindrical magnet 32, and the rotor and the magnetic recording disks 8, which is fitted to the rotor, rotate. Along with this, the voice coil motor 16 swings the swing arm 14, and the read/write head goes back and forth within the swing range on the magnetic recording disk 8. The read/write head converts magnetic data recorded on the magnetic recording disk 8 to an electrical signal and transmits the electrical signal to a control board (not shown). The read/write head also converts data sent from the control board in a form of an electrical signal to magnetic data and writes the magnetic data on the magnetic recording disk 8.

In the rotating device 100 according to the present embodiment, it is possible to mount a plurality of magnetic recording disks 8 on the rotor while keeping the position of the center G of gravity of the rotor within the bearing span. By doing so, it is possible to provide a high-capacity rotating device having improved balance characteristics during rotation.

If a plurality of magnetic recording disks 8 are mounted on the rotor, the separation between the base 4 and the center G of gravity of the rotor increases. Since the rotating device 100 can suppress this increase in separation, tilt of the rotor or the magnetic recording disks due to impact or vibration applied to the rotating device 100 can be suppressed. By doing so, it is possible to improve impact resistance and/or vibration resistance of the fixed-shaft type of the rotating device 100 which has a plurality of magnetic recording disks 8 incorporated therein.

In the rotating device 100 according to the present embodiment, the first taper seal 114 surrounds the second radial dynamic pressure generation portion 162. Therefore, it is possible to widen the bearing span without so many constraints due to the length of the first taper seal 114; thereby radial stiffness of the bearing is improved. Alternatively, it is possible to make the length of the first taper seal 114 greater without being largely limited by the length of the bearing span. This allows a sufficient amount of the lubricant 92 to be stored and this can prevent the lubricant 92 from spreading out.

To sum up, the present embodiment provides the rotating device which (i) can hold more (for example, more than four) magnetic recording disks and (ii) can maintain low error rate due to low center of gravity and to high radial stiffness and (iii) can maintain a sufficient amount of lubricant 92 even after the rotating device has been used for a relatively long time due to the deep capillary seal.

In the rotating device 100 according to the present embodiment, since there is no component to be press-fit into the shaft 26 from downside, it is possible to make the shaft 26 straight (i.e. no steps on the side surface). As a result, the shaft 26 may become easy to make and dimensional accuracy of the shaft 26 may be improved.

Above is an explanation for the structure and operation of the rotating device according to the embodiment. This embodiment is intended to be illustrative only, and it will be obvious to those skilled in the art that various modifications to constituting elements and processes could be developed and that such modifications are also within the scope of the present invention.

The embodiment describes the so-called outer-rotor type of the rotating device in which the cylindrical magnet 32 is located outside the laminated core 40. However, the present invention is not limited to this. For example, the technical concept of the present embodiment may be applied to the so-called inner-rotor type of the rotating device in which the cylindrical magnet is located inside the laminated core.

The embodiment describes the case where the housing is directly mounted onto the base 4. However, the present invention is not limited to this. For example, a brushless motor comprising a rotor and a fixed body can separately be manufactured, and the manufactured brushless motor can be installed on a chassis.

The embodiment describes the case where the laminated core is used. However, the present invention is not limited to this. The core does not have to be a laminated core.

The embodiment describes the case where five magnetic recording disks 8 are mounted on the rotor. However, the present invention is not limited to this . A plurality of magnetic recording disks 8 may be mounted on the rotor. For example, four to six magnetic recording disks 8 may be mounted on the rotor.

The embodiment describes the case where the hub 28 is made of soft-magnetic steel such as SUS430F or aluminum or DHS1 or DHS2. However, the present invention is not limited to this. In general, in order to increase the recording capacity or to increase the recording density, a gap between the read/write head for reading/writing and the magnetic recording disk tends to become small. The smaller the gap is, the more probable it is for tiny extraneous material existing in the gap to cause troubles. The extraneous material existing on the surface of the hub may depart due to a centrifugal force during rotation of the hub and may move to the surface of the magnetic recording disk. Such extraneous material may damage the surface of the disk and may cause troubles.

On the other hand, there are cases where the hub is made by cutting metal material such as aluminum alloy (for example, JIS A6061). For the JIS A6061 aluminum alloy, it is allowed for the material to contain titanium with a ratio less than 0.15 percent. According to research by the inventors, it is recognized that, in the case where the base material contains much titanium, titanium or titanium oxide in the aluminum alloy may depart from the surface of the hub and may become a high density of extraneous material. Such extraneous material may damage the surface of the magnetic recording disk.

To cope with this disadvantage, the hub according to this modification is made by cutting an aluminum alloy which has titanium with a ratio less than 0.05 percent. Components of this aluminum alloy are similar to those of JIS A6061 except for titanium. For the hub according to the present modification, it is confirmed that the amount of detected extraneous material including titanium attached to the surface decreases significantly in comparison with the hub made of standard JIS A6061. It is preferred that the ratio of titanium contained in the material is less than or equal to 0.02 percent. This may further reduce the amount of extraneous material including titanium attached to the surface. It is further preferred that the ratio of titanium contained in the material is less than or equal to 0.01 percent. This may further reduce the amount of extraneous material including titanium attached to the surface. The above kind of disadvantage may exist for the case of components other than titanium; for example, silicon, iron, zinc, chromium. Components to be reduced in the material of the hub or the rate of content may be determined by experiments and analysis of extraneous material attached to the surface of the hub made by cutting.

What is claimed is:

1. A rotating device in which a sleeve of a rotor surrounds a shaft of a fixed body, a lubricant intervening between the shaft and the sleeve, and in which a gap between the shaft and the sleeve includes two dynamic pressure generation portions spaced apart from each other in an extension direction in which the shaft extends,
wherein the rotor and the fixed body are arranged such that a center of gravity of the rotor having a plurality of recording disks mounted thereon is positioned between the two dynamic pressure generation portions.

2. The rotating device according to claim 1, wherein the rotor includes a hub arranged on the sleeve, and
wherein the hub has:
an outer frame portion having an outer cylindrical surface on which central holes of the plurality of recording disks are fit when the plurality of recording disks are mounted on the hub;
an inner frame portion attached to the outer side of the sleeve; and
an intermediate portion provided in between the outer frame portion and the inner frame portion,
wherein the hub is arranged such that a width, in the extension direction, of the intermediate portion ranges from one-tenth to one-fifth of a width, in the extension direction, of the outer cylindrical surface.

3. The rotating device according to claim 2, wherein the fixed body includes:
a core having a ring portion which surrounds the shaft and a plurality of teeth that radially outwardly extend from the ring portion; and
coils wound around the plurality of teeth,
wherein the rotor includes a magnet fixed to the hub, the magnet being magnetized for driving with a plurality of poles along a circumferential direction and arranged to radially face the plurality of teeth,
wherein the outer frame portion includes:
a first ring portion the outer surface of which is a part of the outer cylindrical surface, the first ring portion having a first inner diameter; and
a second ring portion the outer surface of which is another part of the outer cylindrical surface, the second ring portion having a second inner diameter which is greater than the first inner diameter,
wherein the magnet is accommodated in a region defined by an inner surface of the second ring portion and a surface, on the second-surface side, of the first ring portion,
wherein the hub is arranged such that a width, in the extension direction, of the first ring portion ranges from twice to quadruple of a width, in the extension direction, of the intermediate portion.

4. The rotating device according to claim 2, wherein the fixed body includes a core having a ring portion which surrounds both the shaft and the sleeve and a plurality of teeth that radially outwardly extend from the ring portion,
wherein the inner frame portion at least partly enters in a region between the ring portion and the sleeve.

5. The rotating device according to claim 4, wherein the fixed body includes a sleeve surrounding portion for surrounding the sleeve,
wherein the gas-liquid interface of the lubricant touches an inner surface of the sleeve surrounding portion,
wherein the inner frame portion at least partly enters in a region between the sleeve surrounding portion and the ring portion.

6. The rotating device according to claim 1, wherein more than or equal to four recording disks are mounted on the rotor.

7. The rotating device according to claim 1, wherein a communication hole is provided through the sleeve which communicates an end of one dynamic pressure generation portion further from the other dynamic pressure generation portion with an end of the other dynamic pressure generation portion further from the one dynamic pressure generation portion,
wherein the communication hole is arranged such that a length of the communication hole ranges from twenty-times to sixty-times a diameter of the communication hole.

8. A rotating device in which a sleeve of a rotor surrounds a shaft of a fixed body, a lubricant intervening between the shaft and the sleeve,
wherein the rotor includes a hub arranged on the sleeve, and
wherein the hub has:
an outer frame portion having an outer cylindrical surface on which central holes of the plurality of recording disks are fit when the plurality of recording disks are mounted on the hub;
an inner frame portion attached to the outer side of the sleeve; and
an intermediate portion provided in between the outer frame portion and the inner frame portion,
wherein the hub is arranged such that a width, in an extension direction in which the shaft extends, of the intermediate portion ranges from one-tenth to one-fifth of a width, in the extension direction, of the outer cylindrical surface.

9. The rotating device according to claim 8, wherein the fixed body includes:
a core having a ring portion which surrounds the shaft and a plurality of teeth that radially outwardly extend from the ring portion; and
coils wound around the plurality of teeth,
wherein the rotor includes a magnet fixed to the hub, the magnet being magnetized for driving with a plurality of poles along a circumferential direction and arranged to radially face the plurality of teeth,
wherein the outer frame portion includes:
a first ring portion the outer surface of which is a part of the outer cylindrical surface, the first ring portion having a first inner diameter; and
a second ring portion the outer surface of which is another part of the outer cylindrical surface, the second ring portion having a second inner diameter which is greater than the first inner diameter,
wherein the magnet is accommodated in a region defined by an inner surface of the second ring portion and a surface, on the second-surface side, of the first ring portion,
wherein the hub is arranged such that a width, in the extension direction, of the first ring portion ranges from twice to quadruple of a width, in the extension direction, of the intermediate portion.

10. The rotating device according to claim 8, wherein the fixed body includes a core having a ring portion which surrounds both the shaft and the sleeve and a plurality of teeth that radially outwardly extend from the ring portion,
wherein the inner frame portion at least partly enters in a region between the ring portion and the sleeve.

11. The rotating device according to claim 10, wherein the fixed body includes a sleeve surrounding portion for surrounding the sleeve,
wherein the gas-liquid interface of the lubricant touches an inner surface of the sleeve surrounding portion,
wherein the inner frame portion at least partly enters in a region between the sleeve surrounding portion and the ring portion.

12. The rotating device according to claim 8, wherein more than or equal to four recording disks are mounted on the rotor.

13. A rotating device in which a sleeve of a rotor surrounds a shaft of a fixed body, a lubricant intervening between the shaft and the sleeve,
wherein the rotor includes a hub arranged on the sleeve, and wherein the hub has:
an outer frame portion having an outer cylindrical surface on which central holes of the plurality of recording disks are fit when the plurality of recording disks are mounted on the hub;
an inner frame portion attached to the outer side of the sleeve; and
an intermediate portion provided in between the outer frame portion and the inner frame portion,
wherein the fixed body includes:
a core having a ring portion which surrounds the shaft and a plurality of teeth that radially outwardly extend from the ring portion; and
coils wound around the plurality of teeth,
wherein the rotor includes a magnet fixed to the hub, the magnet being magnetized for driving with a plurality of poles along a circumferential direction and arranged to radially face the plurality of teeth,
wherein the outer frame portion includes:
a first ring portion the outer surface of which is a part of the outer cylindrical surface, the first ring portion having a first inner diameter; and
a second ring portion the outer surface of which is another part of the outer cylindrical surface, the second ring portion having a second inner diameter which is greater than the first inner diameter,
wherein the magnet is accommodated in a region defined by an inner surface of the second ring portion and a surface, on the second-surface side, of the first ring portion,
wherein the hub is arranged such that a width, in an extension direction in which the shaft extends, of the first ring portion ranges from twice to quadruple of a width, in the extension direction, of the intermediate portion.

14. The rotating device according to claim 13, wherein the hub is arranged such that a width, in the extension direction, of the intermediate portion ranges from one-tenth to one-fifth of a width, in the extension direction, of the outer cylindrical surface.

15. The rotating device according to claim 13, wherein the ring portion surrounds the sleeve, and
wherein the inner frame portion at least partly enters in a region between the ring portion and the sleeve.

16. The rotating device according to claim 15, wherein the fixed body includes a sleeve surrounding portion for surrounding the sleeve,
wherein the gas-liquid interface of the lubricant touches an inner surface of the sleeve surrounding portion,
wherein the inner frame portion at least partly enters in a region between the sleeve surrounding portion and the ring portion.

17. The rotating device according to claim 13, wherein more than or equal to four recording disks are mounted on the rotor.
